(19) United States
(12) Patent Application Publication
(10) Pub. No.: US 2013/0175364 A1
(43) Pub. Date: Jul. 11, 2013

(54) ATOMIZING NOZZLE WITH HIGH STABILITY

(71) Applicant: Yu-Chiung HUANG, Taichung City (TW)

(72) Inventor: Yu-Chiung HUANG, Taichung City (TW)

(21) Appl. No.: 13/345,909

(22) Filed: Jan. 9, 2012

(51) Int. Cl. B05B 7/10

(52) U.S. Cl. 239/399

(57) ABSTRACT

An atomizing nozzle includes a body, a rotor and a guiding structure. The body has an inlet, an outlet and a passage connecting the inlet to the outlet. The rotor assembled in the passage has first to third sections. The second section is disposed between the first and third sections, and has an outer diameter larger than those of the first and third sections. The guiding structure formed on a surface of the second section has a helical portion and an air passage portion, which is located within a pitch of the helical portion. An external edge of the helical portion abuts upon a wall of the passage. The rotor mounted within the passage cannot generate the significant lateral displacement and raked state, and water or liquid uniformly flows through the air passage portion located on a periphery of the rotor, and the atomizing state becomes stable and uniform.

### BACKGROUND OF THE INVENTION

1. Field of the Invention

The invention relates to the technological field of atomizing a liquid, and more particularly to a structure of an atomizing nozzle with high stability.

2. Related Art

A typical atomizing nozzle includes a body and a rotor disposed in a passage of the body. The body has one end formed with an inlet and the other end formed with an outlet. When the liquid enters the body from the inlet, flows through a gap between the rotor and the passage and is then ejected from the outlet, the liquid can be atomized.

Because the liquid needs to flow through the gap between the rotor and the passage, the gap is about 0.15 mm or larger, so that the liquid can flow through the gap smoothly.

However, the width of the gap is sufficient to make the rotor generate the raked state or lateral displacement within the passage. Thus, when the liquid passes through the gap, the rotor is in an unstable state so that the atomizing effect is unstable. More particularly, the rotor may be pushed against the wall of the passage so that the liquid is biased and cannot uniformly pass through the periphery of the rotor. Consequently, the liquid that is finally sprayed from the outlet cannot be uniformly atomized.

### SUMMARY OF THE INVENTION

It is therefore an object of the invention to provide an atomizing nozzle with high stability, wherein the nozzle is capable of preventing a rotor from generating significant lateral displacement and raked state, and of making the liquid uniformly flow through an air passage portion located on a periphery of the rotor so that the nozzle sprays the stably and uniformly atomized liquid.

To achieve the above-identified object and effect, the invention provides an atomizing nozzle including a body, a rotor and a guiding structure. The body has an inlet, an outlet and a passage connecting the inlet to the outlet. The rotor is assembled in the passage and has a first section, a second section and a third section. The second section is disposed between the first section and the third section. An outer diameter of the second section is larger than an outer diameter of the first section and an outer diameter of the third section. The guiding structure is formed on a surface of the second section of the rotor and has a helical portion and an air passage portion. The air passage portion is located within a pitch of the helical portion, and an external edge of the helical portion abuts upon a wall of the passage.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is an exterior diagram of the invention.

FIG. 2 is an exploded view of the invention.

FIG. 3 is a schematic illustration showing a body structure of the invention.

FIG. 4 is a schematic illustration showing an assembled structure of the invention.

FIG. 5a is a schematic illustration showing a rotor structure of the invention.

FIG. 5b is a schematic illustration showing another structure of the rotor of the invention.

FIG. 5c is a schematic illustration showing still another structure of the rotor of the invention.

FIG. 5d is a schematic illustration showing yet still another structure of the rotor of the invention.

FIGS. 6 and 7 are schematic illustrations showing the rotor structure and a wall of a passage of the invention.

FIGS. 8 and 9 are schematic illustrations showing a chamber structure of the invention.

FIG. 10 is a schematic illustration showing a used state of the invention.

FIG. 11 is a schematic illustration showing a used state of another structure of the invention.

FIG. 12 is an exploded view showing another embodiment of the invention.

### DETAILED DESCRIPTION OF THE INVENTION

The present invention will be apparent from the following detailed description, which proceeds with reference to the accompanying drawings, wherein the same references relate to the same elements.

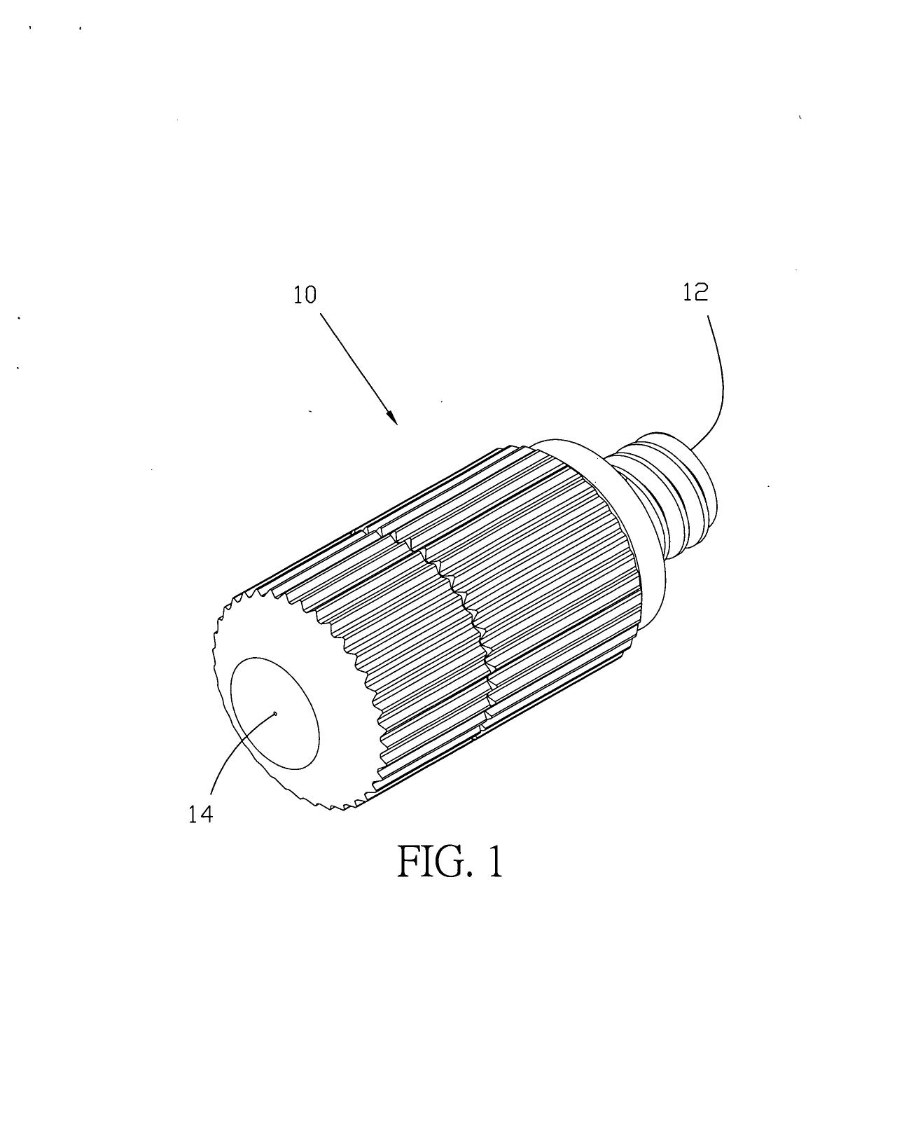

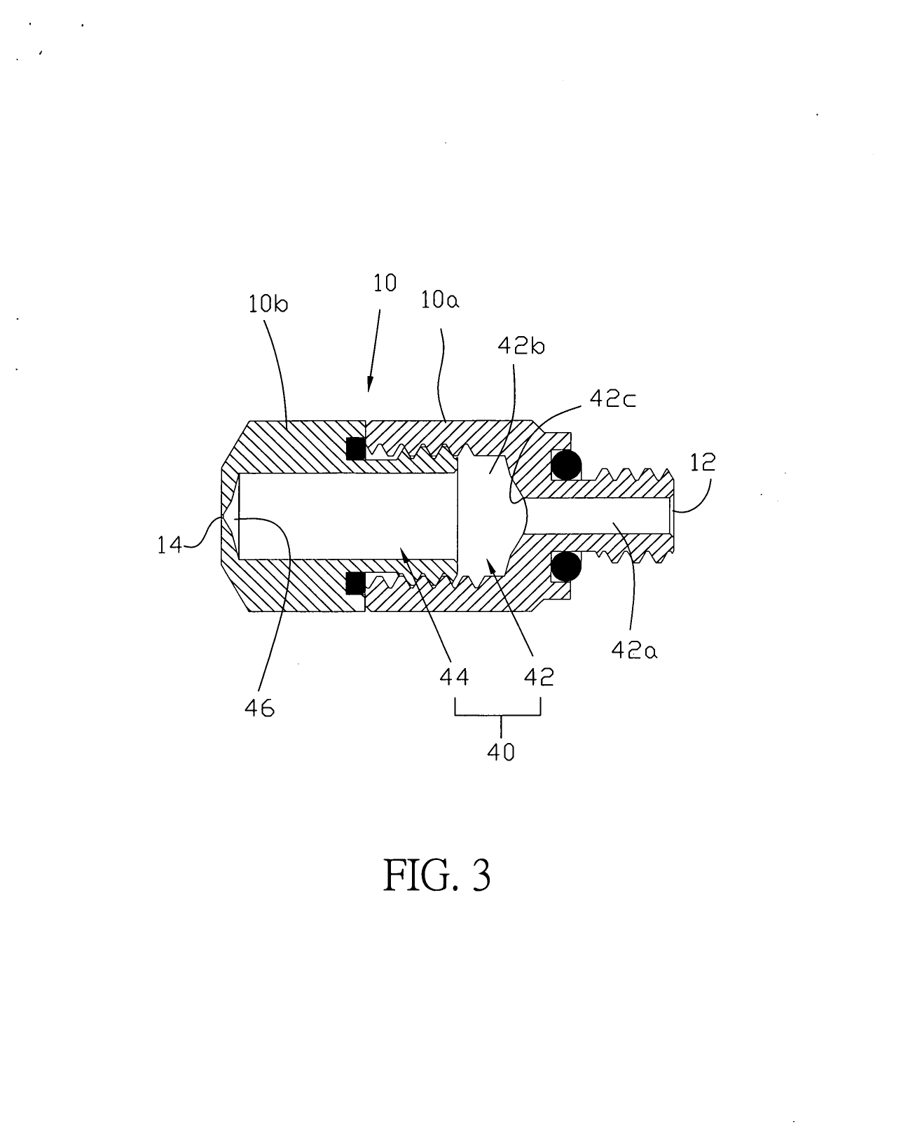

Referring to FIG. 1, an atomizing nozzle has a body (10). The body (10) has one end formed with an inlet (12), and the other end formed with an outlet (14). The body (10) may be composed of one member, two members or three members. Although the body (10) is composed of two members in FIG. 3, the invention is not particularly restricted thereto.

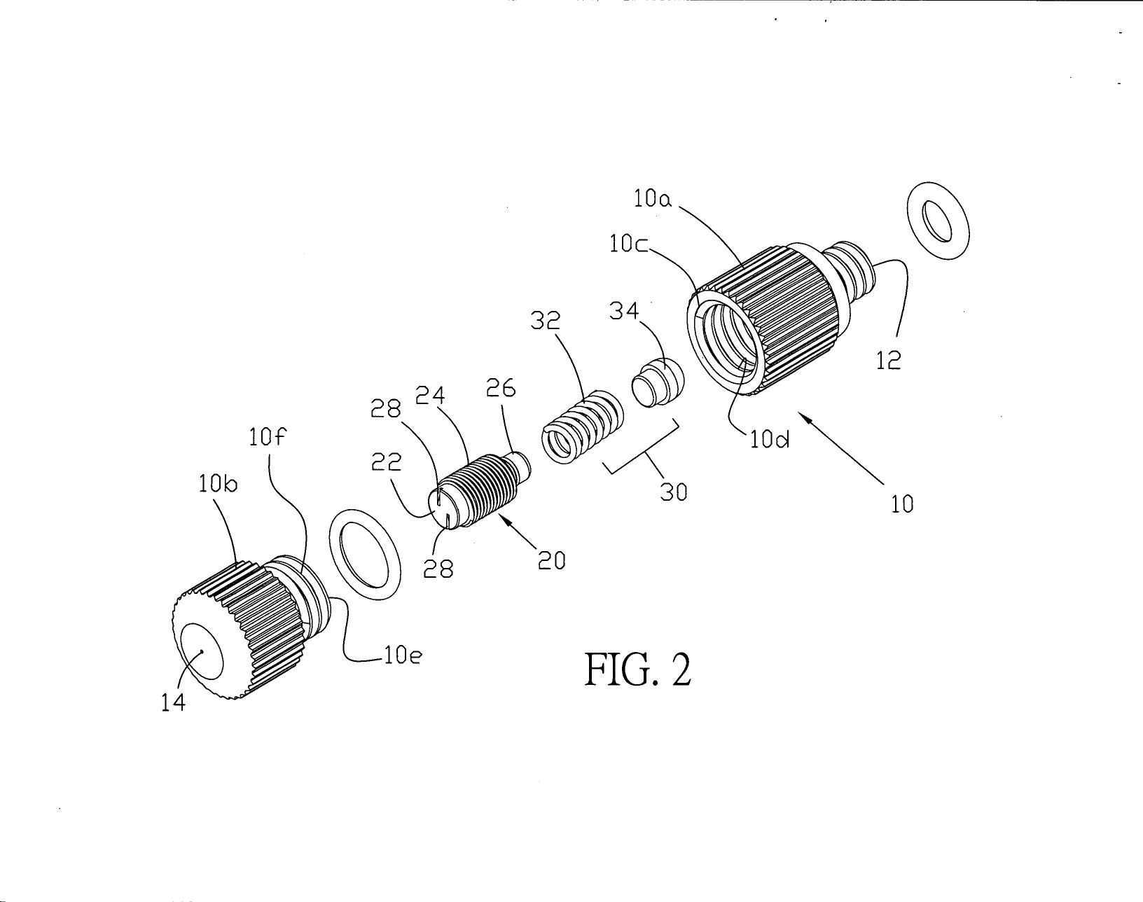

Referring to FIG. 2, the body (10) includes a first member (10a) and a second member (10b) combined together. The inlet (12) is disposed on an end portion of the first member (10a), while the outlet (14) is disposed on an end portion of the second member (10b).

The atomizing nozzle further includes a rotor (20) and a leakage-stopping assembly (30), which are assembled inside the body (10) composed of the first member (10a) and the second member (10b).

The rotor (20) has a first section (22), a second section (24) and a third section (26). The outer diameter of the second section (24) is larger than the outer diameter of the first section (22) and the outer diameter of the third section (26). In addition, two grooves (28) are formed on the end surface of the first section (22) and extended to the lateral side.

The leakage-stopping assembly (30) is composed of a spring (32) and a plug (34) assembled together. The leakage-stopping assembly (30) is combined with the third section (26) of the rotor (20) through the spring (32).

Referring to FIG. 3, the body (10) has a passage (40) extended in an internal axial direction of the body (10). In detail, the first member (10a) has a first sub-passage (42), which is extended in the internal axial direction of the first member (10a) and is connected to the inlet (12). The second member (10b) has a second sub-passage (44) and a chamber (46) extended in the internal axial direction of the second member (10b). The second sub-passage (44) is connected to the first sub-passage (42) to form the passage (40), and the second sub-passage (44) is connected to the chamber (46) and then to the outlet (14) through the chamber (46).

The first sub-passage (42) further includes a narrow passage (42a), a wide passage (42b) connected to the narrow passage (42a), and a resting structure (42c). The narrow passage (42a) has one end connected to the inlet (12), and the other end connected to the wide passage (42b). The resting structure (42c) is formed on the interface between the narrow passage (42a) and the wide passage (42b).

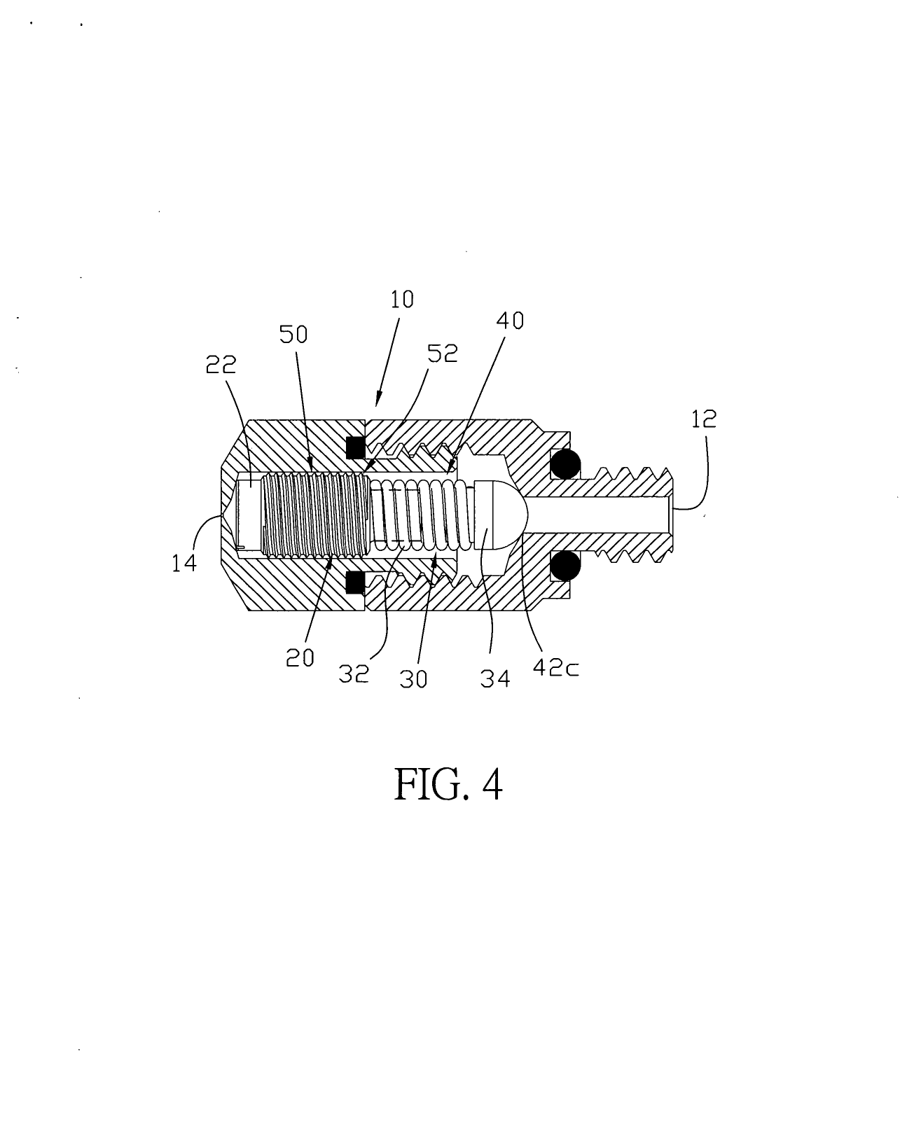

As shown in FIG. 4, the combination of the rotor (20) and the leakage-stopping assembly (30) is accommodated within the passage (40) inside the body (10). The first section (22) of the rotor (20) corresponds to the outlet (14), and the plug (34) corresponds to the inlet (12). Also, the plug (34) can rest against the resting structure (42c) in response to the acting force of the spring (32).

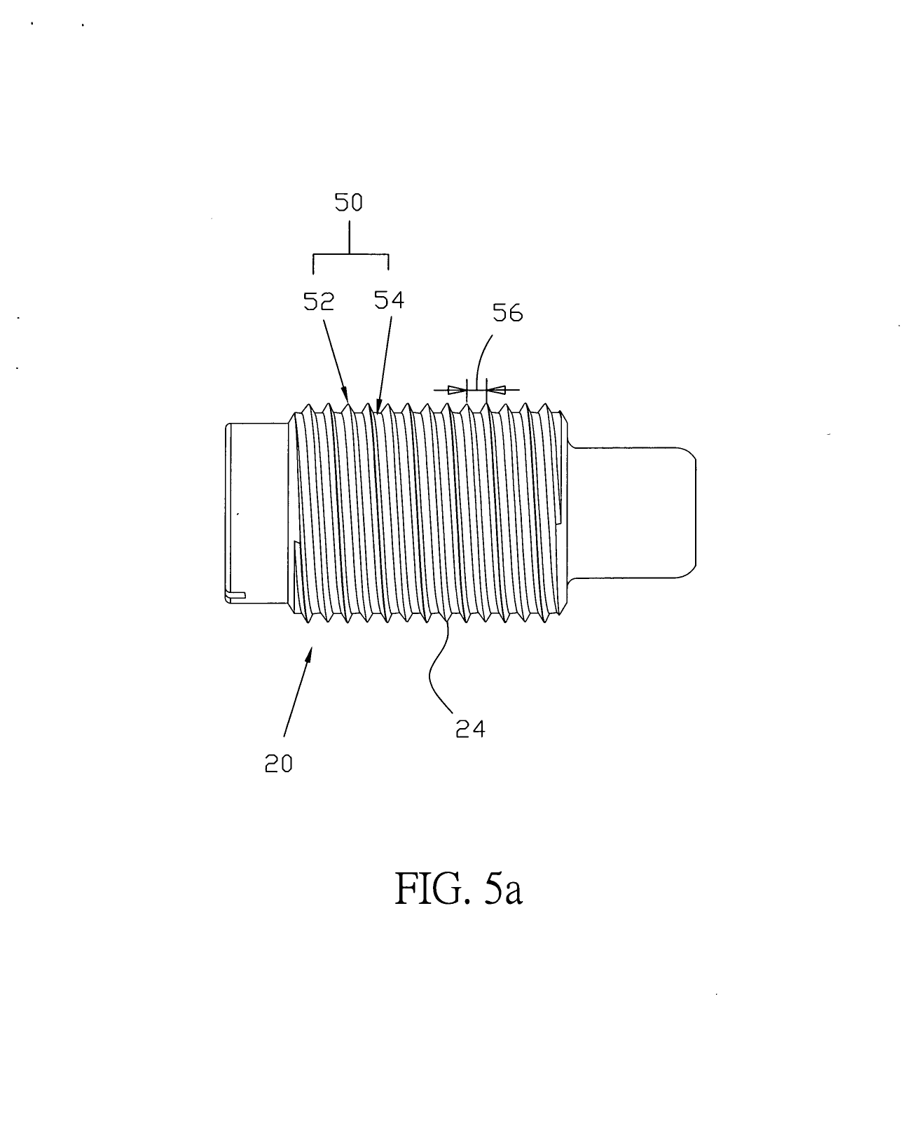

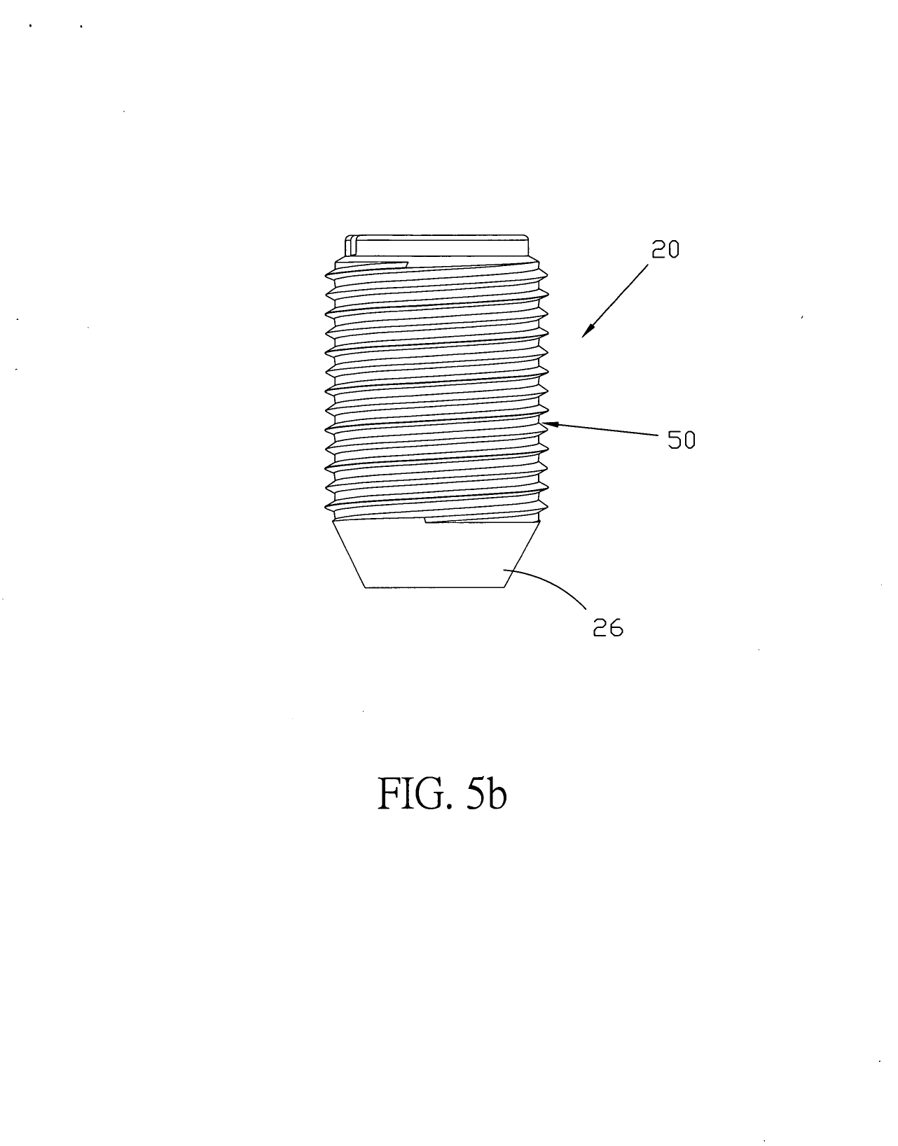

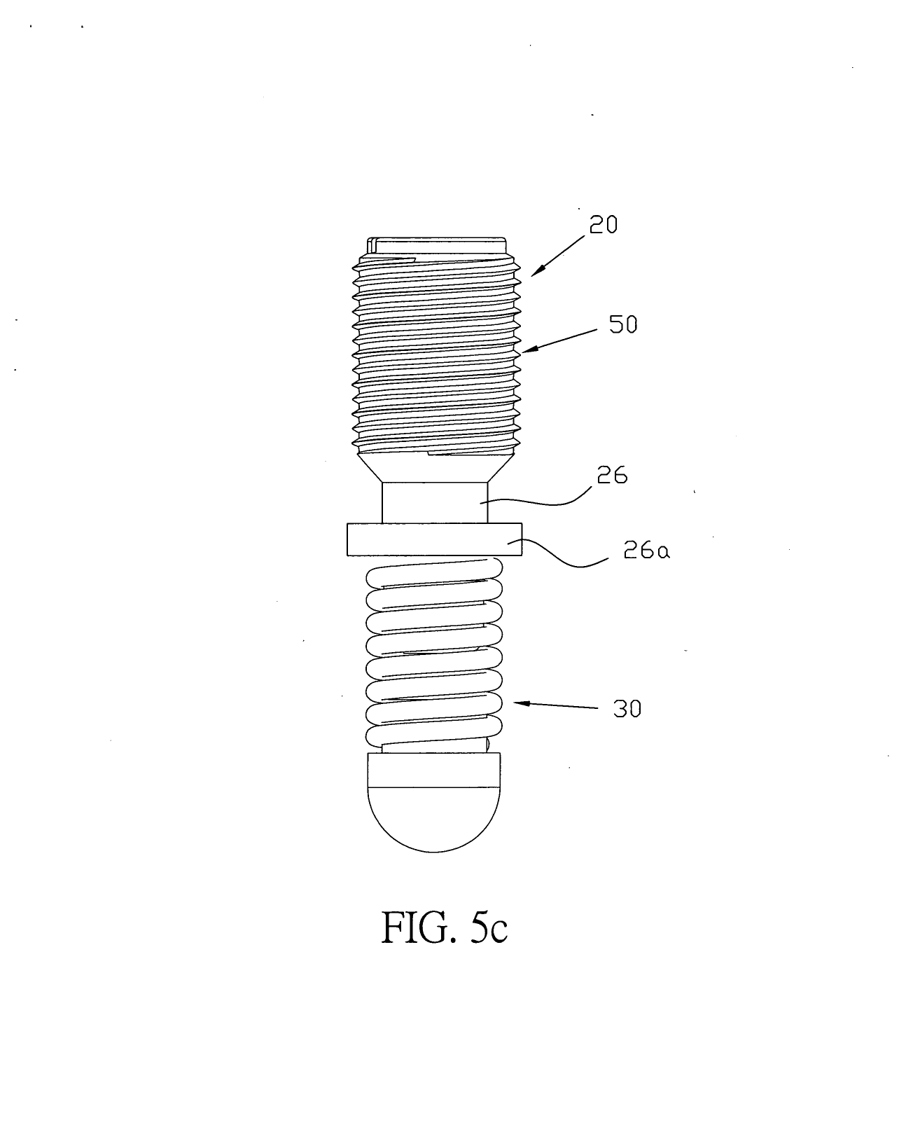

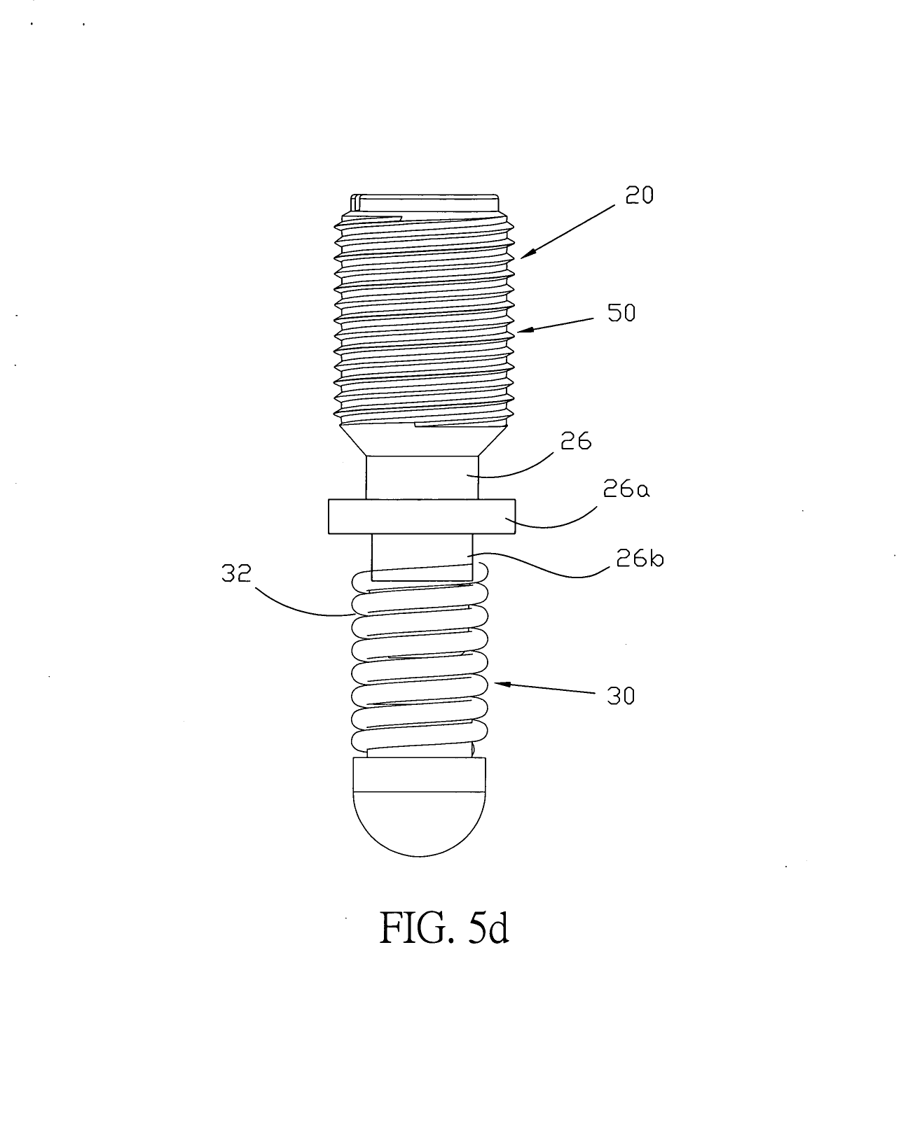

As shown in FIG. 5a, a guiding structure (50) is formed on a surface of the second section (24) of the rotor (20), and has a helical portion (52) and an air passage portion (54), wherein the air passage portion (54) is located within a pitch (56) of the helical portion (52).

In addition to the structure shown in FIG. 5a, the rotor (20) further has the following disclosed structures.

As shown in FIG. 5b, the surface of the rotor (20) is formed with the guiding structure (50), and the third section (26) is formed with a truncated cone structure.

As shown in FIG. 5c, the surface of the rotor (20) has the guiding structure (50), and the end portion of the third section (26) is formed with a stopper portion (26a) which can rest against the leakage-stopping assembly (30).

As shown in FIG. 5d, the surface of the rotor (20) has the guiding structure (50), and the end portion of the third section (26) is formed with a stopper portion (26a) and an extension section (26b) projecting from the stopper portion (26a). Thus, the extension section (26b) may be inserted into the spring (32) of the leakage-stopping assembly (30).

As shown in FIG. 4, the external edge of the helical portion (52) of the guiding structure (50) abuts upon the wall of the passage (40).

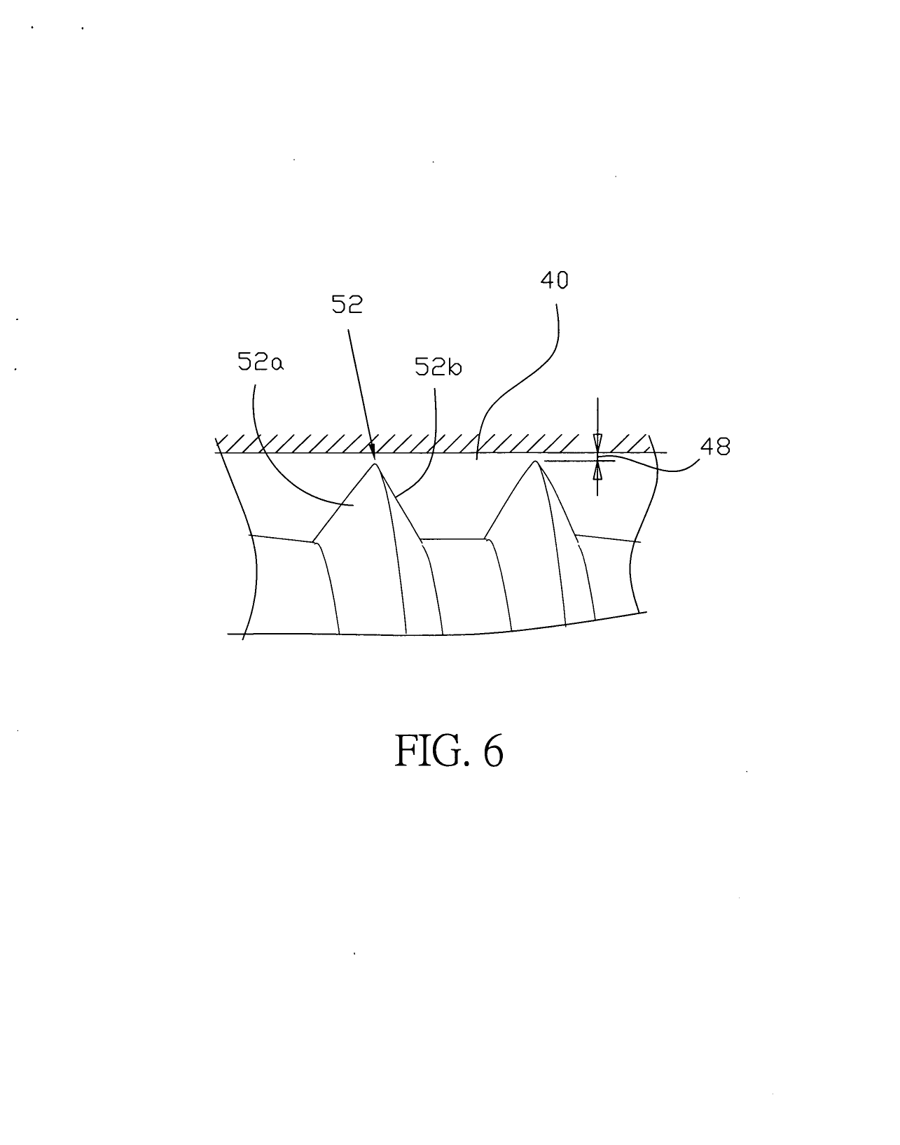

As shown in FIG. 6, the external edge of the helical portion (52) has a first inclined surface (52a) and a second inclined surface (52b), and the first inclined surface (52a) is connected to the second inclined surface (52b).

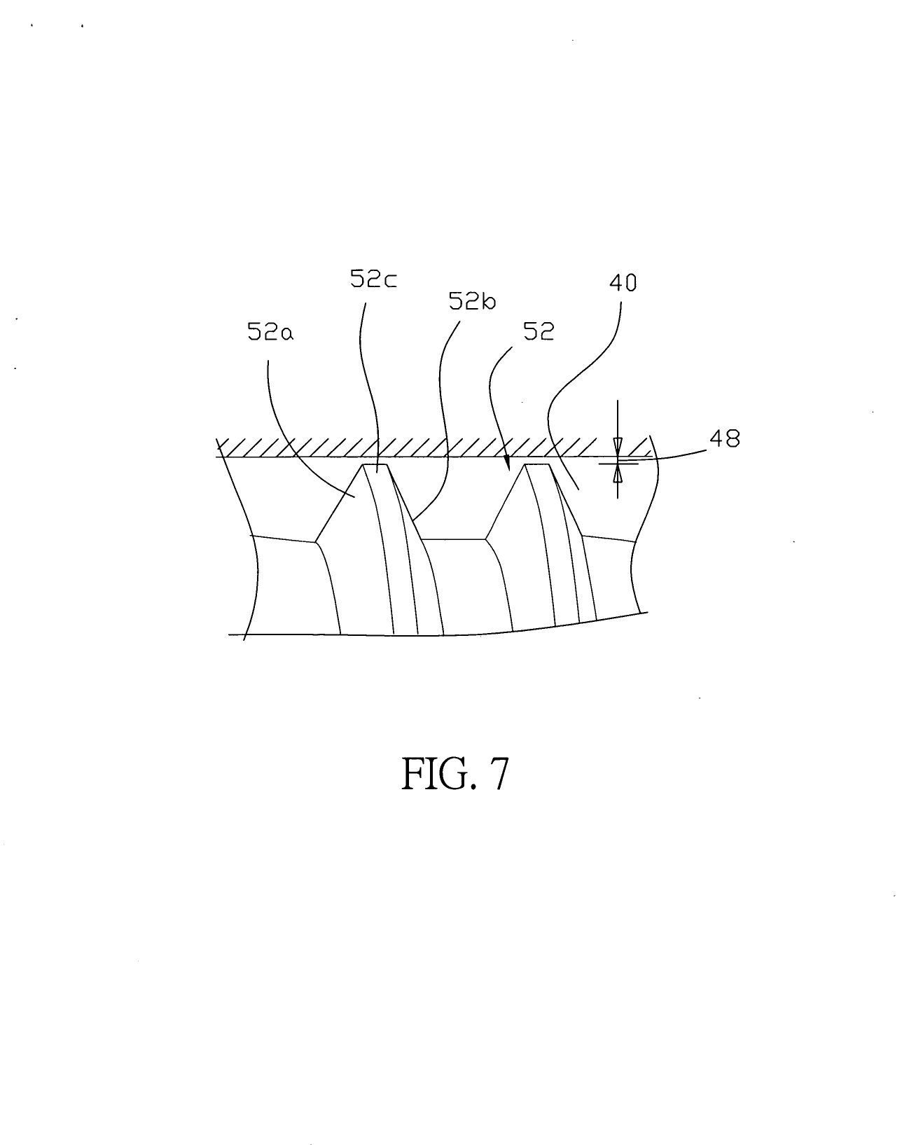

As shown in FIG. 7, the external edge of the helical portion (52) has a first inclined surface (52a), a second inclined surface (52b) and a connecting surface (52c) connecting the first inclined surface (52a) to the second inclined surface (52b).

In the structure disclosed in either FIG. 6 or 7, a gap (48) between the external edge of the helical portion (52) and the wall of the passage (40) is extremely small.

According to the above-mentioned description, it is obtained that the rotor (20) may be mounted within the passage (40) without generating the significant lateral displacement and raked state.

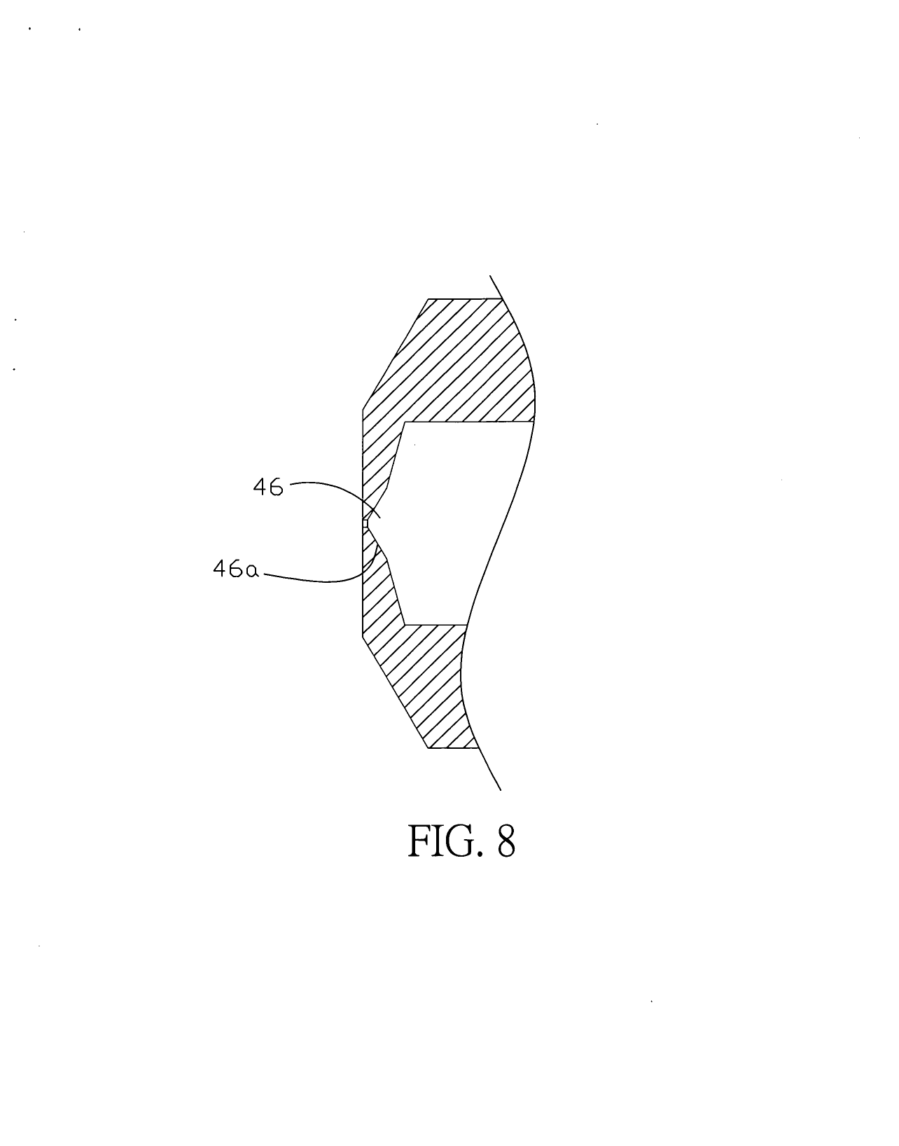

As shown in FIG. 8, the inner wall surface of the chamber (46) may be formed with an inclined surface structure (46a).

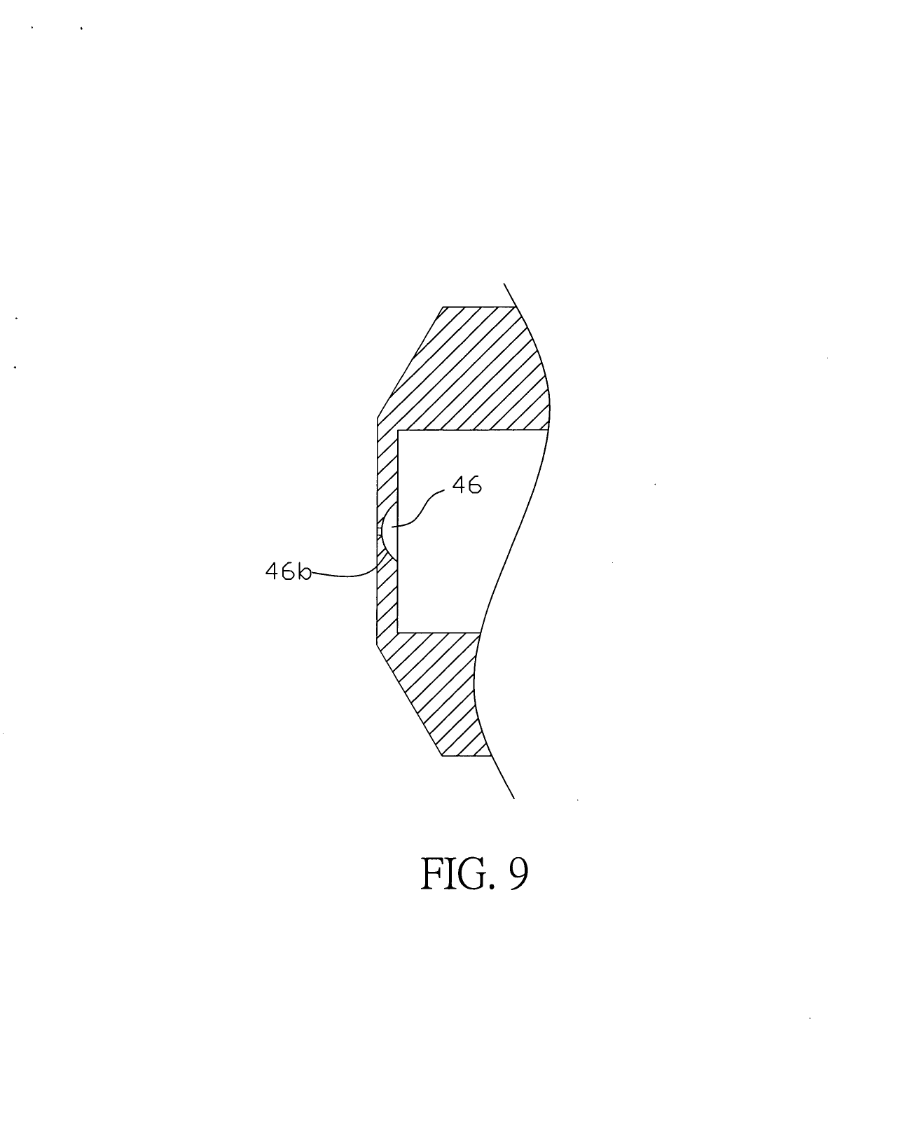

As shown in FIG. 9, the inner wall surface of the chamber (46) may be formed with an arced surface structure (46b).

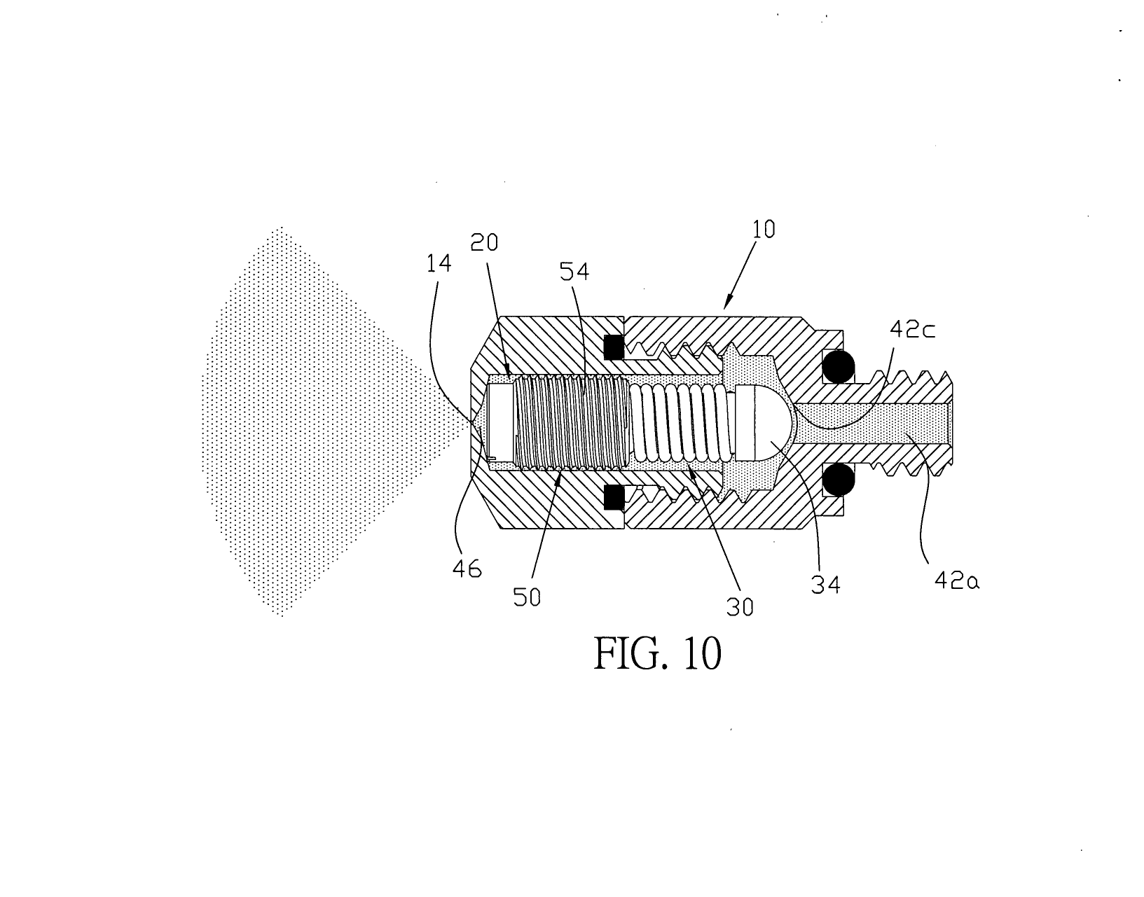

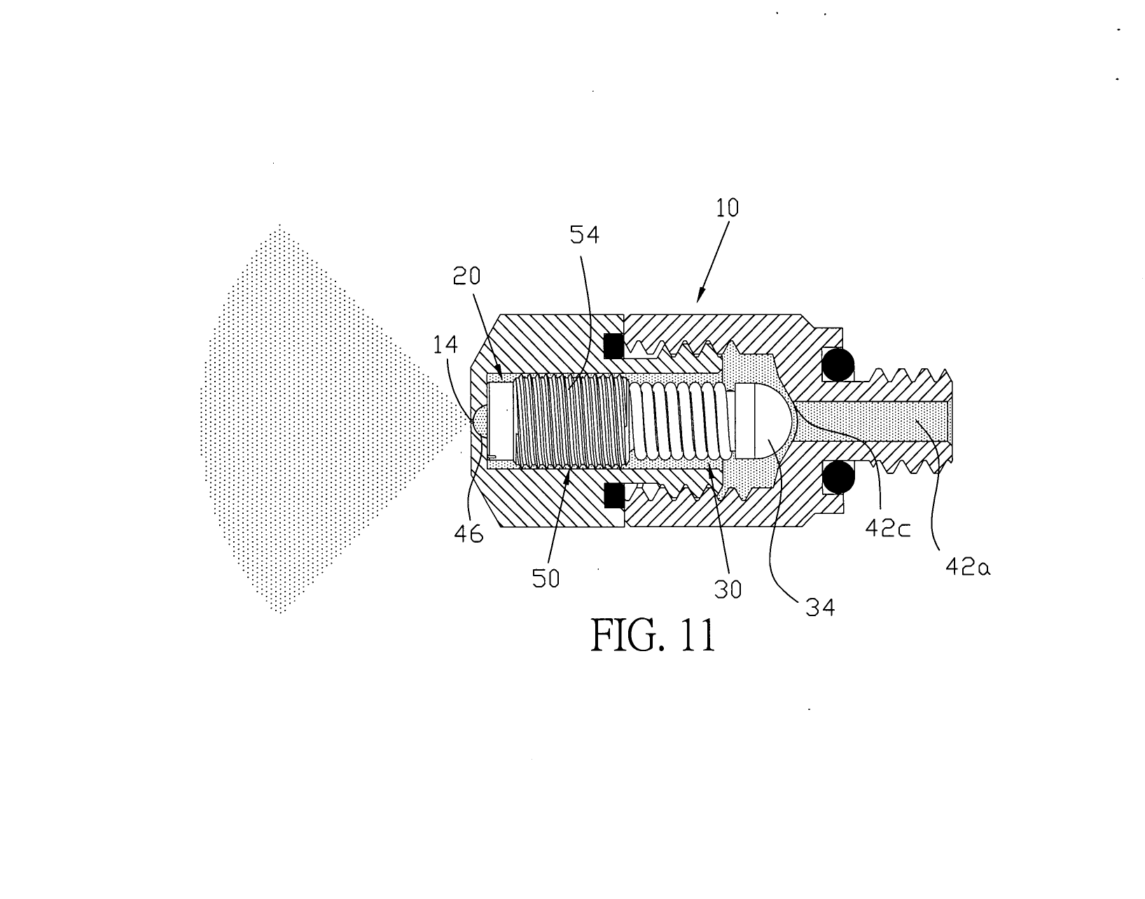

As shown in FIGS. 10 and 11, the water or liquid flowing into the narrow passage (42a) of the body (10) can push the leakage-stopping assembly (30) to move the plug (34) away from the resting structure (42c). Then, the water or liquid travels along the air passage portion (54) of the guiding structure (50), then reaches the chamber (46), and is finally sprayed from the outlet (14).

In the atomizing process, the rotor (20) does not generate the significant raked state and lateral displacement, and the water or liquid can uniformly flow through the air passage portion (54) disposed on the periphery of the rotor (20), so the atomizing state becomes stable and uniform.

The structure according to each embodiment is based on the structure of FIG. 2. The first member (10a) has a screwing hole (10c), and the wall of the screwing hole (10c) has an internal thread structure (10d). One end of the second member (10b) is extended to form a screwing section (10e), and the surface of the screwing section (10e) is formed with an external thread structure (10f). The first member (10a) and the second member (10b) are screwed together through the thread structures of the screwing hole (10c) and the screwing section (10e).

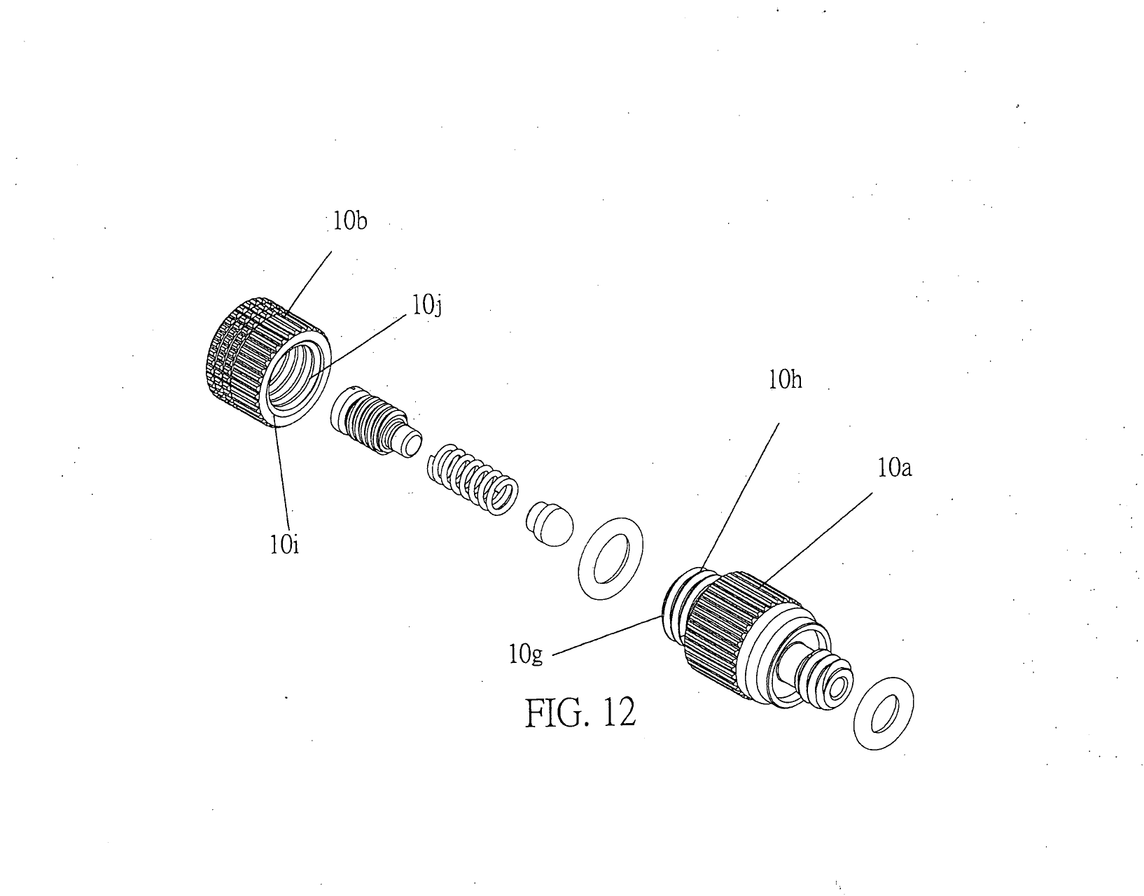

In addition to the above-mentioned combined structure, As shown in FIG. 12, the first member (10a) is extended to form a screwing section (10g), and the wall of the screwing section (10g) has an external thread structure (10h). The second member (10b) has a screwing hole (10i), the surface of the screwing hole (10i) has an internal thread structure (10j). The first member (10a) and the second member (10b) are screwed together through the thread structures of the screwing section (10g) and the screwing hole (10i).

The assembled aspects and the used states of the assemblies of the structures of FIG. 12 are the same as those of FIG. 2, and detailed descriptions thereof will be omitted.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. An atomizing nozzle with high stability, the atomizing nozzle comprising:
a body having an inlet, an outlet and a passage connecting the inlet to the outlet;
a rotor assembled in the passage;
a guiding structure, which is formed on a surface of the rotor and has a helical portion and an air passage portion, wherein the air passage portion is located within a pitch of the helical portion, and an external edge of the helical portion abuts upon a wall of the passage.

2. The atomizing nozzle according to claim 1, wherein the external edge of the helical portion has a first inclined surface and a second inclined surface, and the first inclined surface is connected to the second inclined surface.

3. The atomizing nozzle according to claim 1, wherein the external edge of the helical portion has a first inclined surface, a second inclined surface and a connecting surface connecting the first inclined surface to the second inclined surface.

4. The atomizing nozzle according to claim 1, wherein the rotor has a first section, a second section and a third section, the second section is disposed between the first section and the third section, an outer diameter of the second section is larger than an outer diameter of the first section and an outer diameter of the third section, and the guiding structure is formed on a surface of the second section.

5. The atomizing nozzle according to claim 1, wherein the rotor has a second section and a third section, the guiding structure is formed on the second section surface, and the third section is formed with a truncated cone structure.

6. The atomizing nozzle according to claim 1, wherein the rotor has a second section and a third section, the guiding structure is formed on the second section surface, and the third section has a stopper portion.

7. The atomizing nozzle according to claim 6, further comprising an extension section projecting from the stopper portion.

8. The atomizing nozzle according to claim 1, wherein the body comprises a first member and a second member combined together, the inlet is disposed on an end portion of the first member, and the outlet is disposed on an end portion of the second member.

9. The atomizing nozzle according to claim 4, wherein the first member has a first sub-passage, which is extended in an internal axial direction of the first member and is connected to the inlet, the second member has a second sub-passage and a chamber extended in an internal axial direction of the second member, the second sub-passage is connected to the first sub-passage to form the passage, and the second sub-passage is connected to the chamber and connected to the outlet through the chamber.

10. The atomizing nozzle according to claim 8, wherein one of the first member and the second member has a screwing hole, and the other of the first member and the second member has a screwing section, the screwing hole has an internal thread structure, the screwing section has an external thread structure, and the internal thread structure can be screwed to the external thread structure so that the first member is combined with the second member.
